(19) United States
(12) Patent Application Publication
(10) Pub. No.: US 2012/0052392 A1
(43) Pub. Date: Mar. 1, 2012

(54) ACTIVE MATERIAL FOR NON-AQUEOUS ELECTROLYTE SECONDARY BATTERY, ELECTRODE FOR NON-AQUEOUS ELECTROLYTE SECONDARY BATTERY, NON-AQUEOUS ELECTROLYTE SECONDARY BATTERY, AND METHOD FOR PRODUCING ACTIVE MATERIAL FOR NON-AQUEOUS ELECTROLYTE SECONDARY BATTERY

(75) Inventors: Masanobu Takeuchi, Kobe-shi (JP); Manabu Takijiri, Kobe-shi (JP); Yoshinori Kida, Kobe-shi (JP)

(73) Assignee: SANYO ELECTRIC CO., LTD., Osaka (JP)

(21) Appl. No.: 13/217,001

(22) Filed: Aug. 24, 2011

(30) Foreign Application Priority Data
Aug. 24, 2010 (JP) 2010-187105

(51) Int. Cl. H01M 4/131; C04B 35/64; H01M 4/136

(52) U.S. Cl. 429/223; 429/231.1; 429/231.3; 429/224; 264/614

(57) ABSTRACT

An active material for a non-aqueous electrolyte secondary battery capable of increasing an action potential after the operation of a charge/discharge cycle in a non-aqueous electrolyte secondary battery. The active material for a non-aqueous electrolyte secondary battery includes lithium transition metal composite oxide particles to the surfaces of which boride particles are sintered.

### CROSS REFERENCE TO RELATED APPLICATIONS

The present invention claims priority to Japanese Patent Application No. 2010-187105 filed in the Japan Patent Office on Aug. 24, 2010, the entire contents of which are incorporated herein by reference.

### BACKGROUND OF THE INVENTION

1. Field of the Invention

The present invention relates to a boride-containing active material for a non-aqueous electrolyte secondary battery, an electrode for a non-aqueous electrolyte secondary battery, a non-aqueous electrolyte secondary battery, and a method for producing an active material for a non-aqueous electrolyte secondary battery.

2. Description of Related Art

In recent years, lithium secondary batteries with reduced size and weight and an increase in capacity have been widely used as power supplies for cellular phones. Further, recently, lithium secondary batteries have increasingly attracted attention as power supplies for applications required to have high output, such as electric tools and electric cars. At present, increasing the output of lithium batteries continues to be a large problem.

For example, Japanese Published Unexamined Patent Application No. 10-83818 (Patent Document 1) discloses, as a method for achieving high output characteristics by increasing electron conductivity, a method using a composite material containing graphite or amorphous carbon and another specified material as a conductive agent for a positive-electrode active material. In addition to a metal, an oxide, a nitride, a carbide, and a silicate, a boride is also described as a material which is used for forming a composite material with graphite or amorphous carbon.

### BRIEF SUMMARY OF THE INVENTION

However, as described in Patent Document 1, when a composite material containing a boride and graphite or amorphous carbon is used as a conductive agent for a positive electrode active material, there is the problem of decreasing an action potential by repeating charge/discharge cycles.

The present invention has been achieved in consideration of the above-described point, and an object of the invention is to provide an active material for a non-aqueous electrolyte secondary battery, which is capable of increasing an action potential after the operation of a charge/discharge cycle in a non-aqueous electrolyte secondary battery.

An active material for a non-aqueous electrolyte secondary battery according to the present invention includes lithium transition metal composite oxide particles to the surfaces of which boride particles are sintered. Therefore, a non-aqueous electrolyte secondary battery using the active material for a non-aqueous electrolyte secondary battery according to the present invention has adhesion between the lithium transition metal composite oxide particles and the boride particles having high conductivity even when a charge/discharge cycle is repeated, thereby preferably maintaining a low contact-resistance condition. Therefore, by using the active material for a non-aqueous electrolyte secondary battery according to the present invention, an action potential after the operation of a charge/discharge cycle in a non-aqueous electrolyte secondary battery can be increased.

In addition, boride particles are considered to be simply added as a conductive aid to the lithium transition metal composite oxide. However, in this case, the action potential after the operation of the charge/discharge cycle in the non-aqueous electrolyte secondary battery cannot be sufficiently increased. This is considered to be due to the reason discussed below. When the charge/discharge cycle is repeated, the boride particles having low flexibility cannot follow expansion and contraction of the lithium transition metal composite oxide particles. Therefore, the boride particles are separated from the lithium transition metal composite oxide particles. Consequently, the conductivity improving effect of the boride particles cannot be sufficiently exhibited after the operation of the charge/discharge cycle.

However, according to the present invention, the boride particles are sintered to the surfaces of the lithium transition metal composite oxide particles. Therefore, even when the lithium transition metal composite oxide particles expand or contract, the boride particles are substantially not separated from the lithium transition metal composite oxide particles. The lithium transition metal composite oxide particles and the boride particles are maintained in a low contact resistance condition even after the operation of the charge/discharge cycle. Therefore, the conductivity improving effect of the boride particles can be continuously obtained. As a result, the action potential after the operation of the charge/discharge cycle in the non-aqueous electrolyte secondary battery can be increased.

In addition, for example, particles composed of a material other than the boride have been considered for use as the conductive aid. However, in the present invention, it is necessary to sinter the particles of the conductive aid to the lithium transition metal composite oxide particles. Therefore, the particles of the conductive aid are required to have good heat resistance. In the present invention, in which the particles of the conductive aid are sintered to the lithium transition metal composite oxide particles, it is necessary to use the boride particles having good heat resistance as the particles of the conductive aid.

In addition, the boride is considered to be incorporated into the lithium transition metal composite oxide particles. However, in order to incorporate the boride into the lithium transition metal composite oxide particles, heat treatment at a higher temperature than that of sintering is required. Therefore, in the step of incorporating the boride, the boride is oxidatively decomposed or diffused into the lithium transition metal composite oxide particles and cannot maintain the form of the boride. Thus, the conductivity of the boride is lost. Consequently, even when high-temperature treatment is performed for incorporating the boride into the lithium transition metal composite oxide particles, the action potential after the operation of the charge/discharge cycle in the non-aqueous electrolyte secondary battery cannot be increased.

In the present invention, the lithium transition metal composite oxide particles are preferably composed of a lithium transition metal composite oxide represented by the general formula LiMeO₂ (wherein Me is at least one transition metal selected from Co, Ni, and Mn). In this case, sintering between the boride particles and the lithium transition metal composite oxide particles is strengthened, and thus the strong bonding between the boride particles and the lithium transition metal composite oxide particle is maintained even after the operation of the charge/discharge cycle. Therefore, the action potential after the operation of the charge/discharge cycle in the non-aqueous electrolyte secondary battery can be effectively increased.

Examples of the lithium transition metal composite oxide represented by the general formula LiMeO₂ (wherein Me is at least one transition metal selected from Co, Ni, and Mn) include those having a layered structure, such as LiCoO₂, LiNiO₂, Liₐ(Ni_{b}Co_{c}Mn_{d})O₂ (wherein 0.9≦a/(b+c+d)≦1.2, 0.8≦b/d≦3.0, and 0.2≦c≦0.4), such as LiNi_{0.3}Co_{0.3}Mn_{0.3}O₂, and the like. Among these, Liₐ(Ni_{b}Co_{c}Mn_{d})O₂ (wherein 0.9≦a/(b+c+d)≦1.2, 0.8≦b/d≦3.0, and 0.2≦c≦0.4) is preferably used as the lithium transition metal composite oxide. Although the reason for this is not known, it is considered to be due to the fact that the boride particles are strongly sintered to the surfaces of the lithium transition metal composite oxide particles, and mutual diffusion appropriately occurs between the lithium transition metal composite oxide particles and the boride particles within a range where conductivity is not so decreased.

In addition, the lithium transition metal composite oxide may further contain at least one element selected from the group consisting of aluminum, titanium, chromium, vanadium, iron, copper, zinc, niobium, molybdenum, zirconium, tin, and tungsten.

In the present invention, the boride particles are preferably composed of a metal boride. In this case, the conductivity of the boride particles can be further increased, and good sinterability with the lithium transition metal composite oxide particles can be achieved.

Examples of the metal boride include titanium boride such as TiB₂, zirconium boride such as ZrB₂, hafnium boride such as HfB₂, vanadium boride such as VB₂, niobium boride NbB₂, tantalum boride such as TaB₂, chromium boride such as CrB₂, molybdenum boride such as Mo₂B, MoB, and Mo₂B₅, lanthanum boride such as LaB₆, and the like.

Among these borides, the boride particles preferably contain at least one of titanium boride particles and zirconium boride particles. In this case, in a sintering step, mutual diffusion easily occurs between the boride particles and the lithium transition metal composite oxide particles within a range where the boride is not incorporated into the lithium transition metal composite oxide particles. Therefore, the bonding strength between the boride particles and the lithium transition metal composite oxide particles is possibly increased more. In addition, the mutual diffusion possibly produces a compound, such as titanium boride or zirconium boride, which can efficiently increase the action potential. Further, zirconium or titanium and boron elements simultaneously diffuse into the lithium transition metal composite oxide particles to change the valence of the transition metal in the lithium transition metal composite oxide particles, thereby improving the reactivity with lithium. As a result, the action potential after the operation of the charge/discharge cycle in the non-aqueous electrolyte secondary battery can be further increased.

Lithium transition metal composite oxide particles comprise of secondary particles, which are aggregations of numerous primary particles. For example, hundreds of primary particles with diameters of 1 μm aggregate, and form a secondary particle with an average particle diameter of 10 μm.

In the present invention, preferably, the average particle diameter of the boride particles is 1 μm or more, and is ¼ or less the average particle diameter of the lithium transition metal composite oxide particles (secondary particles). For example, when the average particle diameter of secondary particles is 10 μM, a preferred average particle diameter of the boride particles is less than or equal to ½ of 10 μm, that is, less than or equal to 2.5 μm. See the SEM photograph, which includes a view of the primary particles, a secondary particle and a sintered boride particle.

The primary particles may have a diameter of from 0.5 to 5 μm. The primary particles may have a diameter of from 5 to 20 μm.

When the average particle diameter of the boride particles is excessively small, the reactivity of the boride particles is excessively increased, and thus oxidation or excessive diffusion into the lithium transition metal composite oxide particles may occur during sintering, thereby failing to achieve sufficiently high conductivity. On the other hand, when the average particle diameter of the boride particles is excessively large, it may be difficult to adhere, with high uniformity, the boride particles to the surfaces of the lithium transition metal composite oxide particles.

In the present invention, the amount of the boride particles added is not particularly limited. When the amount of the boride particles added is excessively small, the action potential after the operation of the charge/discharge cycle in the non-aqueous electrolyte secondary battery cannot be sufficiently increased in some cases. On the other hand, when the amount of the boride particles added is excessively large, the energy density of a positive electrode may be excessively decreased. The amount of the boride particles added to the lithium transition metal composite oxide particles is preferably in the range of 0.1 mol % to 5 mol %.

An electrode for a non-aqueous electrolyte secondary battery according to the present invention includes an active material layer containing the above-described active material for a non-aqueous electrolyte secondary battery according to the present invention. By using the electrode for a non-aqueous electrolyte secondary battery according to the present invention, the action potential after the operation of a charge/discharge cycle in a non-aqueous electrolyte secondary battery can be increased.

A non-aqueous electrolyte secondary battery according to the present invention includes the above-described electrode for a non-aqueous electrolyte secondary battery according to the present invention. Therefore, the non-aqueous electrolyte secondary battery according to the present invention exhibits a high action potential after the operation of a charge/discharge cycle. That is, the non-aqueous electrolyte secondary battery according to the present invention has excellent output characteristics.

In a non-aqueous electrolyte secondary battery according to the present invention, for example, the electrode for a non-aqueous electrolyte secondary battery according to the present invention can be preferably used as a positive electrode. In this case, a negative electrode can include a negative-electrode active material layer containing, for example, a carbon material, a metal alloyed with lithium, or an alloy material, or an oxide thereof as a negative-electrode active material. The carbon material is preferably used as the negative-electrode active material. Examples of the carbon material which is preferably used include natural graphite, artificial graphite, mesophase pitch-based carbon fibers (MCF), mesocarbon microbeads (MCMB), coke, hard carbon, fullerene, carbon nanotubes, and the like. Among these materials, low-crystallinity carbon is more preferably used as the carbon material from the viewpoint of achieving higher charge/discharge characteristics.

In a non-aqueous electrolyte secondary battery according to the present invention, a non-aqueous solvent used for a non-aqueous electrolyte is not particularly limited. Non-limiting examples of the non-aqueous solvent include cyclic carbonates such as ethylene carbonate, propylene carbonate, butylene carbonate, vinylene carbonate, and the like; chain carbonates such as dimethyl carbonate, methylethyl carbonate, diethyl carbonate, and the like; and mixed solvents of cyclic carbonates and chain carbonates. Among these solvents, a mixed solvent of cyclic carbonate and chain carbonate, which has low viscosity, a low melting point, and high lithium ionic conductivity, is preferably used as the non-aqueous solvent. In a mixed solvent of cyclic carbonate and chain carbonate, the volume ratio (cyclic carbonate/chain carbonate) of the cyclic carbonate to the chain carbonate is preferably in the range of 2/8 to 5/5.

In addition, an ionic liquid is also a preferable non-aqueous solvent. As a cation of the ionic liquid, pyridium cation, imidazolium cation, and quaternary ammonium cation are preferably used. As an anion of the ionic liquid, fluorine-containing imide anion is preferably used.

As an example of a solute used in the non-aqueous electrolyte, a lithium salt containing at least one element selected from the group consisting of P, B, F, O, S, N, and Cl can be used. Specific examples of the lithium salt include LiPF₆, LiBF₄, LiCF₃SO₃, LiN(CF₃SO₂)₂, LiN(C₂F₅SO₂)₂, LiN(CF₃SO₂)(C₄F₉SO₂), LiC(C₂F₅SO₂)₃, LiAsF₆, LiClO₄, and the like. Among these, LiPF₆ is preferably used as the solute from the viewpoint of achieving excellent charge/discharge characteristics and durability.

A separator interposed between the positive electrode and the negative electrode can be made of, for example, a polypropylene or polyethylene separator or a polypropylene-polyethylene multilayer separator.

A first method for producing an active material for a non-aqueous electrolyte secondary battery according to the present invention relates to a method for producing an active material for a non-aqueous electrolyte secondary battery composed of lithium transition metal composite oxide particles to the surfaces of which titanium boride particles are sintered. The first method for producing an active material for a non-aqueous electrolyte secondary battery according to the present invention includes sintering the titanium boride particles and the lithium transition metal composite oxide particles within the range of 550° C. to 700° C.

A second method for producing an active material for a non-aqueous electrolyte secondary battery according to the present invention relates to a method for producing an active material for a non-aqueous electrolyte secondary battery composed of lithium transition metal composite oxide particles to the surfaces of which zirconium boride particles are sintered. The second method for producing an active material for a non-aqueous electrolyte secondary battery according to the present invention includes sintering the zirconium boride particles and the lithium transition metal composite oxide particles within the range of 600° C. to 750° C.

Each of the first and second methods for producing an active material for a non-aqueous electrolyte secondary battery according to the present invention can produce an active material for a non-aqueous electrolyte secondary battery capable of increasing an action potential after the operation of a charge/discharge cycle in a non-aqueous electrolyte secondary battery. When the sintering temperature of the boride particles and the lithium transition metal composite oxide particles is excessively low, sintering does not sufficiently proceed, and thus the boride particles easily separate from the surfaces of the lithium transition metal composite oxide particles. As a result, the effect of improving the action potential after the operation of the charge/discharge cycle in the non-aqueous electrolyte secondary battery may not be sufficiently obtained. On the other hand, when the sintering temperature of the boride particles and the lithium transition metal composite oxide particles is excessively high, the boride particles may be oxidatively decomposed, and thus the action potential improving effect of the boride particles may not be sufficiently obtained. In addition, a charge/discharge reaction on the surface of the active material for the non-aqueous electrolyte may be inhibited. As a result, the effect of improving the action potential after the operation of the charge/discharge cycle in the non-aqueous electrolyte secondary battery may not be sufficiently obtained.

The atmosphere where the boride particles and the lithium transition metal composite oxide particles are burned is not particularly limited. For example, the boride particles and the lithium transition metal composite oxide particles may be burned in the air.

According to the present invention, the action potential after the operation of the charge/discharge cycle in the non-aqueous electrolyte secondary battery can be increased.

### BRIEF DESCRIPTION OF THE SEVERAL VIEWS OF THE DRAWINGS

FIG. 1 shows a three-electrode test cell formed in examples and comparative examples.

FIG. 2 shows a scanning electron microscope (SEM image) of positive-electrode active material related to Example 1.

### DETAILED DESCRIPTION OF THE INVENTION

The present invention will now be described in detail based on Examples. The present invention is not limited by examples below, and any modification may be made without departing from the scope of the present invention.

### Example 1

### (Preparation of Positive-Electrode Active Material)

First, Ni_{0.3}Co_{0.4}Mn_{0.3}(OH)₂ produced by a coprecipitation method and LiCO₃ were mixed at a molar ratio (Ni_{0.3}Co_{0.4}Mn_{0.3}(OH)₂:Li₂Co₃) of 1:1.1 and burned at 900° C. in air. As a result, lithium transition metal oxide particles having a layered structure and represented by the general formula Li_{1.1}Ni_{0.3}Co_{0.4}Mn_{0.3}O₂ were produced. The average particle diameter of primary particles of the resultant lithium transition metal oxide particles was 1 μm, and the average particle diameter of secondary particles was 10 μm.

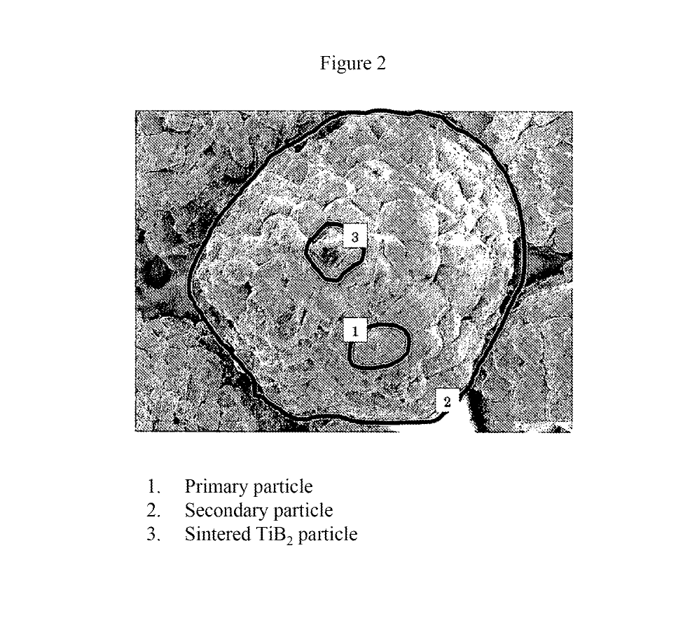

Next, the lithium transition metal oxide particles produced as described above and TiB₂ particles having an average particle diameter of 2 μm were mixed at a molar ratio (lithium transition metal oxide particles:TiB₂ particles) of 99:1 using MECHANOFUSION manufactured by Hosokawa Micron Corporation. Then, the resultant mixture was burned at 550° C. in air to produce a positive-electrode active material. As a result of observation of the resultant positive-electrode active material with a scanning electron microscope (SEM), it was confirmed that the TiB₂ particles are sintered to the surfaces of the lithium transition metal oxide particles. FIG. 2 shows a scanning electron microscope (SEM image) of positive-electrode active material related to Example 1. It was confirmed that TiB₂ particle 3 is sintered on the surface of lithium transition metal composite oxide particle, comprised of a secondary particle 2, which is an aggregation of primary particles 1 of approximately 1 μm.

### (Formation of Positive Electrode)

Next, the positive-electrode active material, vapor-grown carbon fibers (VGCF) serving as a conductive agent, and a N-methyl-2-pyrrolidone solution containing polyvinylidene fluoride as a binder dissolved therein were mixed so that a mass ratio of the positive-electrode active material, the conductive agent, and the binder was 92:5:3, thereby preparing a positive-electrode mixture slurry. The positive-electrode mixture slurry was applied to a positive-electrode current collector composed of an aluminum foil, dried, and then rolled with a rolling roller. Then, an aluminum collector tab was attached to complete a positive electrode.

### (Formation of Three-Electrode Test Cell)

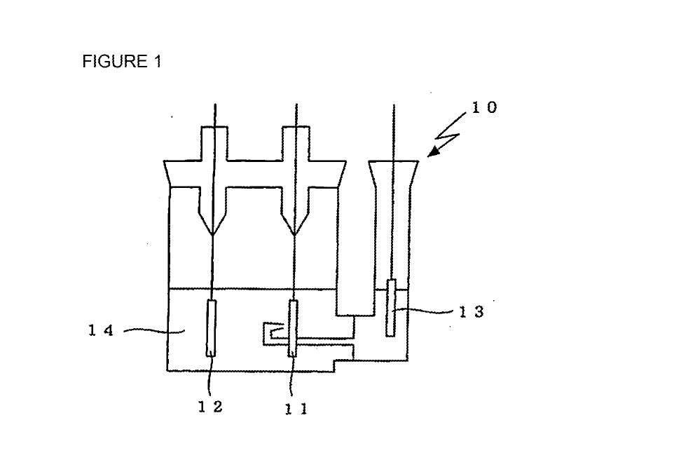

Next, as shown in FIG. 1, a working electrode 11 including the positive electrode formed as described above, a counter electrode (negative electrode) 12 composed of metallic lithium, and a reference electrode 13 composed of metallic lithium were immersed in a non-aqueous electrolyte 14 to form a three-electrode test cell 10. As the non-aqueous electrolyte 14, a solution prepared by dissolving 1 mol/l of LiPF₆ and 1% by mass of vinylene carbonate in a mixed solvent containing ethylene carbonate, methylethyl carbonate, dimethyl carbonate at a volume ratio of 3:3:4 was used.

### Example 2

A positive-electrode active material was prepared by the same method as in Example 1 except that the burning temperature of lithium transition metal oxide particles and TiB₂ particles having an average particle diameter of 2 μm was 600° C. As a result of observation of the resultant positive-electrode active material in this example with a scanning electron microscope (SEM), it was confirmed that the TiB₂ particles are sintered to the surfaces of the lithium transition metal oxide particles.

Next, a positive electrode was formed by the same method as in Example 1 using the positive-electrode active material formed as described above, and then a three-electrode test cell 10 was formed.

### Example 3

A positive-electrode active material was prepared by the same method as in Example 1 except that the burning temperature of lithium transition metal oxide particles and TiB₂ particles having an average particle diameter of 2 μm was 700° C. As a result of observation of the resultant positive-electrode active material in this example with a scanning electron microscope (SEM), it was confirmed that the TiB₂ particles are sintered to the surfaces of the lithium transition metal oxide particles.

Next, a positive electrode was formed by the same method as in Example 1 using the positive-electrode active material formed as described above, and then a three-electrode test cell 10 was formed.

### Example 4

A positive-electrode active material was prepared by the same method as in Example 2 except that ZrB₂ particles having an average particle diameter of 2 μm were used in place of the TiB₂ particles having an average particle diameter of 2 μm. As a result of observation of the resultant positive-electrode active material in this example with a scanning electron microscope (SEM), it was confirmed that the ZrB₂ particles are sintered to the surfaces of the lithium transition metal oxide particles.

Next, a positive electrode was formed by the same method as in Example 2 using the positive-electrode active material formed as described above, and then a three-electrode test cell 10 was formed.

### Example 5

A positive-electrode active material was prepared by the same method as in Example 4 except that the burning temperature of lithium transition metal oxide particles and ZrB₂ particles having an average particle diameter of 2 μm was 700° C. As a result of observation of the resultant positive-electrode active material in this example with a scanning electron microscope (SEM), it was confirmed that the ZrB₂ particles are sintered to the surfaces of the lithium transition metal oxide particles.

Next, a positive electrode was formed by the same method as in Example 4 using the positive-electrode active material formed as described above, and then a three-electrode test cell 10 was formed.

### Example 6

A positive-electrode active material was prepared by the same method as in Example 4 except that the burning temperature of lithium transition metal oxide particles and ZrB₂ particles having an average particle diameter of 2 μm was 750° C. As a result of observation of the resultant positive-electrode active material in this example with a scanning electron microscope (SEM), it was confirmed that the ZrB₂ particles are sintered to the surfaces of the lithium transition metal oxide particles.

Next, a positive electrode was formed by the same method as in Example 4 using the positive-electrode active material formed as described above, and then a three-electrode test cell 10 was formed.

### Comparative Example 1

Lithium transition metal oxide particles having a layered structure and represented by the general formula Li_{1.1}Ni_{0.3}Co_{0.4}Mn_{0.3}O₂ were prepared by the same method as in Example 1.

In the comparative example, the formed lithium transition metal oxide particles were used as the positive-electrode active material without being burned together with boride particles. Then, a positive electrode and further a three-electrode test cell 10 were formed by the same method as in Example 1.

### Comparative Example 2

Lithium transition metal oxide particles having a layered structure and represented by the general formula Li_{1.1}Ni_{0.3}Co_{0.4}Mn_{0.3}O₂ were prepared by the same method as in Example 1.

In the comparative example, the formed lithium transition metal oxide particles were used as the positive-electrode active material. Then, the positive-electrode active material and TiB₂ particles having an average particle diameter of 2 μm were mixed at a molar ratio (lithium transition metal oxide particles:TiB₂ particles) of 99:1 using MECHANOFUSION manufactured by Hosokawa Micron Corporation. Then, the resultant mixture without being burned, vapor-grown carbon fibers (VGCF) serving as a conductive agent, and a N-methyl-2-pyrrolidone solution containing polyvinylidene fluoride as a binder dissolved therein were mixed so that a mass ratio of the mixture, the conductive agent, and the binder was 92:5:3, thereby preparing a positive-electrode mixture slurry. The positive-electrode mixture slurry was applied to a positive-electrode current collector composed of an aluminum foil, dried, and then rolled with a rolling roller. Then, an aluminum collector tab was attached to complete a positive electrode.

Next, a three-electrode test cell 10 was formed by the same method as in Example 1 using the formed positive electrode.

### Comparative Example 3

A positive-electrode active material was prepared by the same method as in Comparative Example 2 except that ZrB₂ particles having an average particle diameter of 2 μm were used in place of the TiB₂ particles having an average particle diameter of 2 μm. Next, a positive electrode was formed by the same method as in Comparative Example 2 using the positive-electrode active material formed as described above, and then a three-electrode test cell 10 was formed.

### (Evaluation of Output Characteristics)

The three-electrode test cell formed in each of Examples 1 to 6 and Comparative Examples 1 to 3 was subjected to stepwise charging including charging at 25° C. and a current density of 0.25 mA/cm² and then charging to 4.3 V (vs. Li/Li⁺) at a current density of 0.025 mA/cm². Next, constant-current discharging to 2.5 V (vs. Li/Li⁺) was performed at a current density of 0.25 mA/cm². The charge/discharge cycle including the stepwise charging and constant-current discharging was repeated 20 times. Then, discharging was performed at 10.0 mAh/cm² to measure an average discharge action potential at the time. The results of measurement are shown in Table 1 below.

TABLE 1

| | | | Average action potential | |
|---|---|---|---|---|
| | | | | Difference from |
| | | Burning | | Comparative |
| | Boride added | temperature (° C.) | (V) | Example 1 (mV) |
| Example 1 | TiB₂ | 550 | 3.36 | +50 |
| Example 2 | TiB₂ | 600 | 3.44 | +130 |
| Example 3 | TiB₂ | 700 | 3.40 | +90 |
| Example 4 | ZrB₂ | 600 | 3.38 | +70 |
| Example 5 | ZrB₂ | 700 | 3.50 | +190 |
| Example 6 | ZrB₂ | 750 | 3.48 | +170 |
| Comparative | No | Without burning | 3.31 | — |
| Example 1 | | | | |
| Comparative | TiB₂ | Without burning | 3.23 | −80 |
| Example 2 | | (mixing) | | |
| Comparative | ZrB₂ | Without burning | 3.31 | ±0 |
| Example 3 | | (mixing) | | |

The results shown in Table 1 indicate that in Examples 1 to 6, in which the boride particles were sintered to the surfaces of the lithium transition metal composite oxide particles, the average action potentials after the operation of the charge/discharge cycle are higher than that of Comparative Example 1 in which the boride particles were not sintered. On the other hand, in Comparative Examples 2 and 3, in which the boride particles were simply mixed with the lithium transition metal composite oxide particles, the average action potentials after the operation of the charge/discharge cycle are equivalent to or lower than that of Comparative Example 1. These results reveal that by sintering the boride particles to the surfaces of the lithium transition metal composite oxide particles, the average action potential after the operation of the charge/discharge cycle can be increased.

The results shown in Table 1 also indicate that when titanium boride is used as a boride, the burning temperature is more preferably in the range of 575° C. to 650° C. In addition, it is found that when zirconium boride is used as a boride, the burning temperature is more preferably in the range of 650° C. to 750° C.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. An active material for a non-aqueous electrolyte secondary battery comprising lithium transition metal composite oxide particles,
wherein the lithium transition metal composite oxide particles have boride particles sintered to surfaces thereof.

2. The active material for a non-aqueous electrolyte secondary battery according to claim 1, wherein the boride particles comprise a metal boride.

3. The active material for a non-aqueous electrolyte secondary battery according to claim 2, wherein the boride particles are selected from the group consisting of titanium boride particles and zirconium boride particles.

4. The active material for a non-aqueous electrolyte secondary battery according to claim 1, wherein the average particle diameter of the boride particles is 1 μm or more and is ¼ or less the average particle diameter of the lithium transition metal composite oxide particles.

5. An active material for a non-aqueous electrolyte secondary battery comprising lithium transition metal composite oxide particles,
wherein the lithium transition metal composite oxide particles have boride particles sintered to surfaces thereof and
wherein the lithium transition metal composite oxide particles comprise a lithium transition metal composite oxide represented by the general formula LiMeO₂, wherein Me is at least one transition metal selected from Co, Ni, and Mn.

6. The active material for a non-aqueous electrolyte secondary battery according to claim 5, wherein the boride particles comprise a metal boride.

7. The active material for a non-aqueous electrolyte secondary battery according to claim 6, wherein the boride particles are selected from the group consisting of titanium boride particles and zirconium boride particles.

8. The active material for a non-aqueous electrolyte secondary battery according to claim 5, wherein the average particle diameter of the boride particles is 1 μm or more and is ¼ or less the average particle diameter of the lithium transition metal composite oxide particles.

9. An active material for a non-aqueous electrolyte secondary battery comprising lithium transition metal composite oxide particles,
wherein the lithium transition metal composite oxide particles have boride particles sintered to surfaces thereof,
wherein the lithium transition metal composite oxide particles comprise a lithium transition metal composite oxide represented by the general formula LiMeO₂, wherein Me is at least one transition metal selected from Co, Ni, and Mn and
wherein the average particle diameter of the boride particles is 1 μm or more and is ¼ or less the average particle diameter of the secondary particles of the lithium transition metal composite oxide particles.

10. An active material for a non-aqueous electrolyte secondary battery comprising lithium transition metal composite oxide particles,
wherein the lithium transition metal composite oxide particles have boride particles sintered to surfaces thereof,
wherein the lithium transition metal composite oxide particles comprise a lithium transition metal composite oxide represented by the general formula LiMeO₂, wherein Me is at least one transition metal selected from Co, Ni, and Mn, and
wherein the boride particles comprise a metal boride.

11. An electrode for a non-aqueous electrolyte secondary battery comprising:
an active material layer containing the active material for a non-aqueous electrolyte secondary battery according to claim 1.

12. An electrode for a non-aqueous electrolyte secondary battery comprising:
an active material layer containing the active material for a non-aqueous electrolyte secondary battery according to claim 5.

13. An electrode for a non-aqueous electrolyte secondary battery comprising:
an active material layer containing the active material for a non-aqueous electrolyte secondary battery according to claim 9.

14. An electrode for a non-aqueous electrolyte secondary battery comprising:
an active material layer containing the active material for a non-aqueous electrolyte secondary battery according to claim 10.

15. A non-aqueous electrolyte secondary battery comprising:
the electrode for a non-aqueous electrolyte secondary battery according to claim 1.

16. A non-aqueous electrolyte secondary battery comprising:
the electrode for a non-aqueous electrolyte secondary battery according to claim 5.

17. A non-aqueous electrolyte secondary battery comprising:
the electrode for a non-aqueous electrolyte secondary battery according to claim 9.

18. A non-aqueous electrolyte secondary battery comprising:
the electrode for a non-aqueous electrolyte secondary battery according to claim 10.

19. A method for producing an active material for a non-aqueous electrolyte secondary battery comprising lithium transition metal composite oxide particles, wherein the lithium transition metal composite oxide particles have titanium boride particles sintered to surfaces thereof, the method comprising:
sintering the titanium boride particles and the lithium transition metal composite oxide particles at a temperature within the range of 550° C. to 700° C.

20. A method for producing an active material for a non-aqueous electrolyte secondary battery comprising lithium transition metal composite oxide particles, wherein the lithium transition metal composite oxide particles have zirconium boride particles sintered to surfaces thereof, the method comprising:
sintering the zirconium boride particles and the lithium transition metal composite oxide particles at a temperature within the range of 600° C. to 750° C.
